(19) United States
(12) Patent Application Publication
(10) Pub. No.: US 2013/0006722 A1
(43) Pub. Date: Jan. 3, 2013

(54) Universal vehicle management system

(76) Inventors: Christopher Louis Ziomkowski, Pathumthani (TH); Paul Anthony Giles, Bangkok (TH)

(21) Appl. No.: 13/137,345

(22) Filed: Aug. 8, 2011

Related U.S. Application Data
(60) Provisional application No. 61/401,337, filed on Aug. 10, 2010.

(51) Int. Cl. G07B 15/02

(52) U.S. Cl. 705/13

(57) ABSTRACT

A universal vehicle management apparatus that can be installed on any means of conveyance, including means of conveyance where installation would result in significant exposure to environmental hazards, and including a rating system that can handle complex fare calculations from a plurality of sensors.

### CROSS REFERENCE TO RELATED APPLICATIONS

This application claims the benefit of PPA Ser. No. 61/401,337, filed 2010 Aug. 10 by the present inventors, which is incorporated by reference.

### FEDERALLY SPONSORED RESEARCH

Not Applicable

### SEQUENCE LISTING OR PROGRAM

Not Applicable

### BACKGROUND—FIELD

This invention relates to a taxi meter, and more particularly to an apparatus providing automated fare calculations and operating statistics and designed to be installed on any means of conveyance including traditional automobiles, motorcycles, autorickshaws, pedicabs, bicycles, trailer carts and other for hire means used for transport or errands.

### BACKGROUND OF THE INVENTION

The global for hire transport industry is big business, and wildly diverse. Such diversity creates difficulty in properly designing equipment and services that can appeal to everyone and offer uniform advantages to both commercial and independent operators in disparate countries. However, public transport users are increasingly becoming globalized and do not appreciate these same restrictions. They tend to judge quality and convenience based on their experiences in other regions, and demand similar levels of service. Passengers, operators and regulatory authorities are increasingly frustrated and concerned with finding ways to bring some uniformity and service guarantees to the global industry despite the enormous challenges associated with that task.

A huge challenge in the industry today is that taxi fleet operators with heterogeneous means of conveyance need a solution for managing them in a similar way.

In the prior art, a taxi fleet operator can purchase an advanced vehicle management system for his traditional automobile taxis. However, the onboard vehicle management devices in the prior art are not protected against environmental hazards, and thus a taxi fleet operator cannot use them to manage his means of conveyance which do not provide a protected environment from the atmosphere, such as is the case on motorcycles, tricycles, bicycles, and trailer carts among others, without worrying about significantly shortening the life of the operating electronics and voiding the warranty. Means of conveyance in the taxi fleet which are not enclosed and therefore not suitable for vehicle management systems in the prior art are typically administered completely manually.

Manual administration of a taxi fleet is expensive, inefficient and prone to error. While it is possible for the operator of a means of conveyance to record all data in a log book, such a process is tedious to the operator, and real world concerns such as collecting the next fare paying passenger often relegate such less important data logging activities to secondary consideration. All the time spent manually recording this data is time not spent transporting fare paying passengers, and the lack of efficiency means more vehicles must be placed in service in order to accomplish the same task.

Even where the size of the taxi fleet consists of only a single vehicle, and the operator of the means of conveyance is independent, it is common to forget or otherwise neglect the task of rigorously recording all critical data on every trip. This leads to an operator being unable to analyze his driving profiles to determine how to increase profits, as well as possibly missing critical service milestones because careful records were not kept.

Finally, certain kinds of data such as fuel usage that can be achieved by a vehicle management device with appropriate transducers are not available at all in a manual mode. This lack of information does not allow the operator of a means of conveyance to optimize his revenue generating potential by shifting working hours to those mathematically most advantageous.

Another problem in the industry is that independent taxi operators may have multiple means of conveyance, and need a universal vehicle management system with fare meter that can work similarly in all of them.

An independent taxi operator with multiple means of conveyance may select the most appropriate at different times of the day. For example, during heavy rain a traditional enclosed taxi may be the means of conveyance most in demand by the public. However, during peak periods with heavy traffic, a motorcycle that can move quickly across town may be more profitable. In the prior art, the operator would need to use a distinct fare meter or vehicle management device for each type of vehicle he operates.

This approach requires a specific vehicle management device or simple fare meter be purchased for each means of conveyance. This is more expensive for the operator. Further, differences in operation mean that an operator of a means of conveyance must learn the proper operation of several devices, resulting in more confusion and the requirement to consciously be aware of which device he is operating. This is in contrast to what could occur if the devices were identical and automatic reflex could be developed that did not require significant attention and worked across all means of conveyance. Since transporting passengers through traffic is often distracting, negligence starting the meter and failures to record operating parameters are more common, thus leading to reduced revenue and more stressful conditions.

A further problem faced by independent taxi operators is that they may be renting their means of conveyance. In this case, having a fixed vehicle management system on the taxi will mean that independent renting operators cannot take advantage of the enhanced efficiencies afforded by a vehicle management system. In the prior art, every time they rent they will receive a different taxi with a different vehicle management apparatus that has multiple operator's data sets. A more serious issue arises in jurisdiction where fares are not regulated, or where fares may be regulated for certain aspects, such as simple journeys, but unregulated for more complicated errands. In these instances, in order to make use of a fare meter, the operator must be sure that his exact tariffs are installed on that meter. This is impossible when the meter is being shared among many renting operators.

Another problem in the industry is that taxi operators using means of conveyance that do not provide a protected environment from dust, rain, atmospheric pollutants and insects have different rating and surcharging requirements from operators who use an enclosed means of conveyance. For example, while a rainstorm may be a moderate inconvenience that merely results in a slower journey in a traditional taxi, a simple problem that will be compensated for by the standard fare schedule, a rainstorm for an operator of a means of conveyance such as a motorcycle taxi can be a serious health hazard. The operator of the means of conveyance that does not provide an enclosed, protected environment must add surcharges to compensate for additional risks.

Additionally, taxi operators who operate means of conveyance that do not provide a protected environment often operate from fixed queues rather than roaming transit corridors looking for passengers. The nature of these queues of open air means of conveyance such as motorcycles create additional problems which are not solved by the fare meters and dispatch services of the prior art. Specifically, the priority of a vehicle in a queue of traditional automobile taxis is often easily deduced from the order in which the vehicles are situated. Since automobiles are large and generally parked parallel to the curb, it is quite obvious that the vehicle at the front is the first in the queue. As a passenger comes and he accepts the fare, the remaining vehicles simply move forward in a continuous fashion.

Queues with open air means of conveyance such as motorcycles do not provide such a simple means of identification. Often, motorcycles do not even park on the street, but on sidewalks or footpaths. When they do park on the street, it is generally at an angle nearly perpendicular to the curb. Because operators generally eschew stopping extremely close to another operator, this leaves gaps in the queue that tend to get filled as the queue becomes crowded. Thus, it becomes impossible to deduce order of driver priority from the physical location at the queue. Local mechanisms are used in the prior art to overcome this inherent problem. A popular mechanism used in the prior art is for drivers to leave their keys on a board with hooks. As a passenger comes, the driver whose key is in the first position removes his key and accepts the fares. The remaining keys are then shuffled forward. This board and key system acts as a proxy for the well ordered physical queues that are characteristic of automobile taxis. Unfortunately, it is common for the driver to forget to place his key on the queue system when he arrives, leading to confusion and disputes about when he arrived and where his key should be placed when he realizes the error.

Additionally, taxi operators who work from fixed queues and operate means of conveyance that do not provide a protected environment have frequent interaction with the local population. The convenience and familiarity by the local population of the operators at these fixed queues lead to requests for performing errand services, which have more complex fare calculations than traditional fare meters in the prior art can accommodate.

For example, shutting down the engine and turning off the electrical system on a fare meter in the prior art will cancel the active fare. However, for an operator of a means of conveyance on an errand, multiple errands or performing various taskwork for hire (such as paying bills, charging a battery, and repairing items), this action may require a switch to a different fare schedule or the imposition of a surcharge. When the operator returns having received or delivered the item and restarted the means of conveyance, the fare meter may still need to be active and calculating the fare.

In the prior art, an operator of a means of conveyance where extremely complex fare structures would be required, such as journeys that involve errands, must rely on instinct and experience to estimate the charges that would be appropriate for any given journey or action involving a complex surcharge or errand. The operator of the means of conveyance must then enter into negotiations with the customer to arrive at a cost that is acceptable to both parties.

Operators who are new to the industry may not possess the knowledge or skill to properly estimate these charges, or they may lack the conviction to negotiate a fair price. Even operators who are very experienced may not enjoy the confrontational attitude that sometimes develops when customers do not accept the requested fare. In these cases, the operator of a means of conveyance may lose revenue that would not have occurred if an automated means of calculating charges were available.

Another problem in the industry is that taxi operators who operate means of conveyance that do not provide a protected environment are at risk for theft of the meter.

Taxi fare meters in the prior art that are designed to be installed on means of conveyance that do not provide an enclosed and secured environment are simply bolted onto the means of conveyance. While one skilled in the art may be aware of specific instances where operators have attempted to weld a tab onto the fare meter and secure it to the means of conveyance with a cable or similar structure, there are no standard mechanisms in the prior art that address physical security of the fare meter. A skilled thief, trained and with proper tools, could easily remove a fare meter in the prior art in much less than a minute. Even where a thief fails to steal a meter or is uninterested in completely removing the meter, vandalism is another serious problem encountered by operators when their means of conveyance does not provide a secured environment.

The theft of a vehicle management device with fare meter not only results in lost profits due to the necessity to purchase a new device, it also results in revenue lost during the time after the theft and before a new device can be installed and certified. Furthermore, the critical statistical data that may be stored in the stolen device cannot be replaced, thus inhibiting the operator's ability to optimize his performance.

Many operators of means of conveyance that do not provide a secured environment lack the technical ability to custom engineer an appropriate security solution. There may be no available individual skilled in the art to assist him in such an endeavor, and the necessary parts and resources may not be available to develop a secure solution on a case by case basis when special custom, factory molded parts are required for proper function.

Another serious problem in the industry is that vehicles such as taxis used in for hire transportation require the most advanced safety equipment in order to maximize benefits to the public. While most recent automobiles sold in developed countries such as the USA may have event data recorders, older vehicles that are often used as taxis do not. Many other vehicles used in the for hire transport such as motorcycles have no commercial options for event data recorders. This lack of a critical safety feature constitutes a public health threat to transit users. An Aug. 11, 2003 article in Forbes magazine reports that a German taxi company installed event data recorders in its taxi fleet and traffic collisions dropped by 66%. With such dramatic increases in safety possible, it is critical that these solutions be made available to the public in a commercially viable manner.

Many examples of event data recorders for modern automobiles exist in the prior art. The first were installed by GM in 1974 and were used to record data about air bag deployment. Several national governments have passed or are in the process of passing laws to require event data recorders in all new vehicles sold. Unfortunately, the regulatory requirements are still far from settled, and only a few industrialized countries have adopted them. Thus it will be a long time before equipment such as this is included automatically at the factory.

Because motorcycles do not have air bags, and the current event data recorders on the market all evolved from air bag deployment systems, there are no significant installations of event data recorders for motorcycles. Similarly, there are no known event data recorders for auto rickshaws, tricycles, bicycles, or other means of conveyance that are often used in for hire transportation in place of automobiles. At the same time, while there are fewer safety devices for these vehicles, safety is a much more serious concern.

The lack of this safety equipment costs thousands of lives globally per year, as traffic accidents can result in fatalities. Another problem with the approach in the prior art is that operation of taxis is indirectly rendered substantially less efficient, as insurance rates are higher, and when accidents do happen the vehicle is unavailable for more journeys, leading to inefficiency of asset use. Also, without event data recorders police are often unable to properly assign fault at an accident, and often unfairly blame the taxi drivers who are unlikely to be wealthy and important citizens, especially if they are operating a relatively inexpensive means of conveyance such as a motorcycle.

While these are examples of problems, an expert in the art will recognize many other problems similar to this which will be solved by the present invention discussed in detail below.

### SUMMARY OF THE INVENTION

With regard to the problem of taxi fleet operators with heterogenous means of conveyance need a solution for managing them in a similar way, the present invention provides a vehicle management apparatus in an environmentally sealed housing that can be installed on any class of vehicle including those which do not provide effective protection from environmental hazards. This allows a taxi fleet operator to install the unit on any means of conveyance in his fleet. Because the same device is installed on all vehicles and possesses the same interface and the same data is being recorded, he can manage all means of conveyance in exactly the same manner.

With regard to the problem that independent taxi operators may have multiple means of conveyance, and need a universal vehicle management system with fare meter that can work similarly in all of them, the present invention creates a vehicle management apparatus with integrated rating system and may be installed, removed and then reinstalled on multiple different means of conveyance independent of vehicle class or whether the means of conveyance provides protection from environmental hazards. Only the sensing means and a vehicle specific storage means for vehicle related data needs to be purchased and installed on each means of conveyance an independent taxi operator wishes to use. Based on feedback from the sensing means, the vehicle management apparatus will determine which means of conveyance is currently being used and adjust the fare schedules automatically to match. All digital logs from all means of conveyance attached to the vehicle management apparatus will be available for the operator in a consistent format.

An important aspect of meter portability between means of conveyance is to maintain the calibration of the device on each means of conveyance where it will be installed. In one embodiment, all calibration data is stored encrypted in a small, persistent storage device that is physically attached and paired on a one to one basis with the sensing means on that means of conveyance. When the meter is connected to this means of conveyance, it loads the data from the persistent storage means via a secure protocol over the local vehicle network. An alternative embodiment may store multiple vehicle profiles on the meter itself and use an algorithm, or stored vehicle identifier in persistent storage on the means of conveyance, to determine which calibration profile to load.

For independent taxi operators who rent their means of conveyance, the present invention allows them to transfer their vehicle management device between different vehicles. The data stored in their personal device belongs to them. When their shift begins, they plug in the universal vehicle management apparatus, and when the shift ends, they unplug it and take it home. All the data stored in that device and all programming belongs to the operator and not to the taxi. An external storage means located on the vehicle may also record information specifically related to managing the vehicle in this case. In localities where there is no regulation of fare prices, or regulation of only certain fare prices and other fare rates are left open to the market, this means each operator renter can program his own fares and be sure that he will be able to use the meter in any vehicle.

The problem of the complex queueing requirements of taxi operators using a means of conveyance that park on footpaths or perpendicular to the curb is addressed by the present invention through the use of an intelligent, electronic queueing algorithm integrated into the meter. A wireless communications means establishes the operator's arrival at either a fixed queue location identified by wireless queue beacon, or an adhoc queue established when a plurality of operators park within a short distance sufficient for communication between the individual meters, and turn off their engines. Alternatively, in an embodiment equipped with a GPS receiver, GPS coordinates can be used to establish arrival at a queue. In any case, the meters themselves note their arrival time at the fixed or adhoc queue, and automatically establish a priority for the operators based on an algorithm. In the present embodiment, the algorithm is simply priority based on arrival time at the queue location, however an alternative embodiment may integrate a fare balancing mechanism whereby the driver having earned the least amount of money for the day is automatically promoted to the head of the queue.

An additional feature of the intelligent queueing mechanism is the ability to logically group geographically distributed waiting locations into a single logical queue, and dispatch operators to remote locations from the logical queue based on a metric which accounts for queue priority and distance from the customer. A wireless communication means between the vehicle management devices is used to establish to location and priority of each operator within the group, and customers are allowed to hail a taxi from known geographical locations by sending a signal including the geographic identifier to a coordinating vehicle management device or coordinating queueing beacon, hereinafter called the coordinating entity, within the logical group. The coordinating entity establishes the location of the highest priority operators within the queueing group, and their current distance from the customer's location. An algorithm is used to assign a preference to each operator in the queue, and then the vehicle management device of the most preferred operator displays the request for a taxi and a description of the location of the customer. If the operator does not acknowledge the fare within a preset period of time, the coordinating entity automatically signals the next most preferred operator until either there are no more operators to be signalled, or an operator acknowledges the request. If no operator acknowledged the request, the coordinating entity restarts the algorithm to assign a preference to each operator in the queue and once again cycles through the list of operators. This process continues until an operator acknowledges the request or the customer cancels the request for a taxi.

In the present embodiment, this functionality is implemented through a series of taxi stops at convenient locations throughout a given area. The taxi stops are equipped with a wireless receiver and transmitter, which are capable of sending and receiving messages both to other taxi stops as well as to the vehicle management systems of operators within the logical queue. A customer approaches the taxi stop and signals his desire for a taxi through the use of a personal wireless transmitter. This request is relayed through the wireless network to the coordinating entity that prioritizes the operators first by physical distance to the taxi stop, and then by priority within the queue. The closest, highest priority operator is signalled to pick up the passenger by displaying the alphanumeric identifier of the taxi stop on the operators vehicle management system. The operator is given a short period to acknowledge the fare before the vehicle management device times out and the fare is passed to the next available operator. In the event the customer leaves the taxi stop before a taxi operator arrives, the queueing system will note the departure by the personal transmitter of the customer moving out of range and automatically cancel the request. If the taxi operator subsequently arrives at the taxi stop after the customer has left, the vehicle management device will note the cancellation and the operator will not lose his original location within the queue.

The customer's personal handheld transmitter may optionally be equipped with a display means that will show the credentials of the operator dispatched to the taxi stop, as well as their expected time of arrival.

To coordinate which operator is assigned to which customer in the event where there are several customers waiting at the same taxi stop for an operator, the operator's vehicle management device will automatically contact the personal transmitter of the customer it has been dispatched to service, and the personal transmitter will blink an LED, or show in a graphical or textual manner on a display means if the tranmitter is so equipped, to signal the current taxi has been paired to that customer.

With regard to the problem that taxi operators using means of conveyance that do not provide a protected environment from dust, rain, atmospheric pollutants and insects have different rating and surcharging requirements from operators who use an enclosed means of conveyance, and that they may have more complex fare calculations than traditional fare meters in the prior art can accommodate, one embodiment of the present invention provides a programmable fare schedule structure that is created using a plurality of inputs to record either delta, periodic, or completely custom events. Such events are used to load or unload tariff structures into a list of active tariffs in the current fare schedule based on a database of event types embedded in the fare schedule. Additionally, each event can cause the update of the current total fare with a programmable surcharge. Delta events are transient. They occur, are processed, and then deleted. Periodic events are processed and then automatically reoccur at specific time intervals until they are cancelled by another event. Completely custom events are processed and then run a customized programmable script that can trigger new events or schedule itself to reoccur at a later time.

In this embodiment of the invention, a plurality of data input means includes data from the sensing means providing metric events about the vehicle distance travelled and derivative information, a wireless means communicating events from landmarks that are being traversed external to the means of conveyance, a serial means providing feedback from a geographical location monitor providing events regarding the exact position of the means of conveyance, a chronological means providing elapsed time, time of day and date information events, a power monitoring means providing events about to the running condition of the means of conveyance, including whether a mechanical engine is currently being utilized or not, and a manual input means providing human feedback about events currently recognized by the operator.

Every event provided by any of the plurality of data input means can load or complete a surcharge tariff from the active list of tariffs which make up the current fare schedule. Surcharges can take on any value, including a negative value which would indicate a credit. Periodic events from the chronological input means may calculate surcharges based on all active tariffs from the current fare schedule in real time, or alternatively the installation of an active tariff may be marked with a timing means, and when the tariff is removed from the current fare schedule all periodic events that occurred between the event time and the previous timestamp will be processed.

An end of journey event will be indicated by the operator and arrive on the manual input means, and such event will have the effect of removing all active tariffs from the current fare schedule. This will as a result total the final calculated fare which is displayed to the user. A reset event from the manual input means will cause the calculated fare to reset to zero.

This mechanism is substantially more sophisticated than the simple rate, time and distance fare schedules which are used in vehicle management systems with integrated fare meters in the prior art. The completely customizable events which utilize a programmable scripting language to determine their functionality allow a programmer in the locality where the vehicle management apparatus is to be used to create any function desired including ones that are non linear, geographically specific, or even random.

The mechanism is also not limited to working in a single currency. Each tariff of a fare schedule may be specified in any appropriate currency or even non currency accounting structures such as bonus points or ration coupons. Where an exchange rate exists between the tariff currency and the primary display currency, charges will be automatically translated into the primary display currency and kept as a single running balance. Where no such exchange rate is practical or warranted, such as with the use of bonus points or ration coupons, the primary fare will be displayed, and the alternative accumulated accounting values will be flashed for brief but readily viewable periods on the vehicle management device display means. At the end of a journey, the primary display fare may be converted into any alternative currency for which an exchange rate exists. A country which uses dual currencies such as the US Dollar and Cambodian Real, or the US Dollar and the Mexican Peso, can be quickly toggled between any programmed currency at the touch of a button at the end of a journey. Periodic exchange rates may be updated by wireless or serial communication means.

In the case of a situation where government rationing is in effect and customers must exchange rationing coupons or rationing points in addition to a currency, the vehicle management device can maintain the current accumulated value of those coupons which can then be wirelessly exchanged at authorized locations for restricted items like fuel, tires or motor oil.

Other implementations of a programming mechanism that can achieve similar results to the one described here will be familiar to one skilled in the art. Such alternatives are also included in the present invention and should be views as equally valid implementations.

With regard to the problem that taxi operators who operate means of conveyance that do not provide a protected environment are at risk for theft of the meter, the present invention provides a security means directly on the vehicle management apparatus to make the process of theft extremely difficult. In one preferred embodiment of the invention, the theft prevention mechanism includes fitting a quick release clamp on the mounting of the vehicle management apparatus and bisecting the cable containing the power and data conduits and fitting the bisected cable with a sealed connector. Theft prevention is affected by quickly removing the device from the means of conveyance whenever the operator is away from his vehicle. Alternate embodiments of the invention may include physically welding the enclosure to a means of conveyance, or providing a sophisticated locking mechanism requiting a key to remove the device or access the mounting bolts. In an embodiment with a microcontroller physically attached to the sensor network on the means of conveyance and where the means of conveyance includes a signalling device such as a car horn, removing the meter without first entering a passcode can trigger an alarm. In the event the vehicle management apparatus was unlawfully removed, the device may also include a locator algorithm that uses signals from a GPS, Loran, GSM triangulation, or motorcycle queue beacons to determine its position and send and report its status to police or a security agency who can retrieve the device.

An additional advantage of being portable, that is, compact and easily removable by hand, not only provides theft protection but also protects against vandalism and accidental damage (e.g., collision/bike falling over) as well as allowing for quick removal in an emergency and for ease of care, storage, calibration, programmability, downloading and updating, service, maintenance and inspection, thus lessoning its exposure to the elements, insects and other hazards which will increase the lifespan of the product. This also allows different processes such as calibration, maintenance and inspection to be simultaneously simplified yet more encompassing and revealing by allowing the meter to be scrutinized independently of the vehicle on which it is used.

Another unique advantage afforded by portability is the opportunity for operators to identify themselves when they are on foot in a location such as an airport where people are disembarking from a plane, or other areas where their vehicle cannot go or are otherwise restricted. While ID cards or identification tags can be readily forged, the presence of a taxi meter on an operator soliciting passengers can be used to clearly and unabiguously identify the operator of a means of conveyance as a certified and licensed driver by the locality. The data stored in the meter itself and the wireless interface can immediately provide officials responsible for enforcement or safety with the credentials of the operator and his authorization to solicit customers at that location.

Another advantage of portability is the ability of the meter to be used for non vehicular modes of transport such as when carried by humans or other living creatures. The gate associated with an animal is typically uniform for a given animal and acceleration imparted by the step of that animal, and this input can be used to estimate the distance travelled in such circumstances where the meter has been properly calibrated. This can be used for metering fares involving walking for errand services or transport over extremely difficult terrain in remote areas where even motorcycles are impractical.

To address the problem that many vehicles used globally in the for hire transport industry do not have event data recorders installed, the present invention combines the similar requirements required for a universal taxi vehicle management system and event data recorders to arrive at an integrated solution for operators of for hire transport at a much lower price point than would be available by purchasing these devices separately. For some means of conveyance, the present invention provides a solution for an event data recorder which does not currently exist.

Both the universal vehicle management apparatus and event data recorders require an environmentally sealed enclosure as well as an enclosure that can prevent tampering. Both devices require certification by regulatory authorities, both devices require periodic inspections to verify they are performing as expected, and both devices require the data they produce to be password protected, yet easily downloaded by a relevant authority.

In addition to significant cost savings afforded by a combined event data recorder and universal vehicle management apparatus for the operator of a means of conveyance, the new combination also allows an operator to perform all his certification requirements during a single service visit at a single facility, thus saving time and increasing his operating efficiency.

### FIGURES

FIG. 1 is an exploded view of the universal vehicle management apparatus with integrated rating system.

FIG. 2 is an exploded view of the mirror mounting bracket for the universal vehicle management apparatus with integrated rating system.

FIG. 3 is view of the printed circuit board and electronics assembly incorporated into the universal vehicle management apparatus with integrated rating system.

FIG. 4 is a right side cutaway view of the universal vehicle management apparatus with integrated rating system.

FIG. 5 is a block diagram of the objects used for the advanced programmable rating system incorporated in the universal vehicle management apparatus with integrated rating system.

FIG. 6 is a conceptual block diagram of an event data recorder incorporated into the universal vehicle management apparatus with integrated rating system.

### DRAWING REFERENCE NUMERALS

Item 6 is an acrylic faceplate.

Item 7 is a top half clamshell enclosure composed of an ABS polymer material.

Item 8 is a silicone rubber keypad and sealing sheet.

Item 9 is a printed circuit board and electronics.

Item 10 is a bottom half clamshell enclosure composed of an ABS polymer material.

Item 11 is a silicon rubber button with the function of turning the rating engine and display on and off.

Item 12 is an LED to indicate a low internal battery condition.

Item 13 is an LED to indicate a service warning condition.

Item 14 is a silicon rubber button assigned the function of stopping the rating engine at the end of the journey.

Item 15 are 4 general purpose silicon rubber menu buttons assigned the function of selecting a fare schedule, selecting one of a plurality of passengers, or selecting one of several operating modes.

Item 16 is a silicon rubber button assigned the function of resetting the rating engine and LEDs (20), (21), (22) and (23) to their default state after a journey has been completed.

Item 17 is a silicon rubber button assigned to a general purpose “DOWN” function that is used in all operating modes to increase a value under consideration.

Item 18 is a silicon rubber button assigned to a general purpose “UP” function that is used in all operating modes to decrease a value under consideration.

Item 19 is a silicon rubber button assigned to the pause function which will temporarily suspend rating until the button is pressed again.

Item 20 is a 7 segment ultrabright LED display that shows the current flag drop rate plus surcharges during a journey.

Item 21 is a 7 segment ultrabright LED display that shows the current standing time or total journey time during a journey.

Item 22 is a 7 segment ultrabright LED display that shows the current distance traveled during a journey.

Item 23 is a 14 segment ultrabright LED display that shows the current fare for the journey as well as alphanumeric text messages relevant to the journey.

Item 24 is a microprocessor that provides the programmable functions of the universal vehicle management apparatus with integrated rating device.

Item 25 is a wireless interface chipset that communicates via RF or microwave radio to external devices.

Item 26 is a connector on the PCB that provides leads for power, an external serial connector, and a sensor that provides information about the distance travelled by the taxi.

Item 27 is a serial flash component that provides storage for the programmable functions of the rating device as well as a digital diary of all journey information.

Item 28 are 8 tamper evident screws that are used to attach the upper (7) and lower (10) clamshell enclosure halves together and indicate if the enclosure has been opened.

Item 29 is a cable with quick disconnect connector that provides power, sensor data, and a serial port for the universal vehicle management apparatus with integrated rating device.

Item 30 is a screw used to assembly the mirror mount for the universal vehicle management apparatus with integrated rating device.

Item 31 is a mirror based mounting plate for the universal vehicle management apparatus with integrated rating device.

Item 32 is an opening in the mirror based mounting plate (31) designed to allow passage of the cable (29).

Item 33 is a hemispherical hinge that allows the mirror mounting plate (31) to move in 2 axis.

Item 34 is a combination receptacle for the hemispherical hinge (33) and front clamp for attaching the universal vehicle management apparatus with integrated rating device to the mirror of a vehicle.

Item 35 is a typical mirror stem from a motorcycle.

Item 36 is a quick disconnect screw for tightening the two halves (34) and (37) of the clamp that goes on the mirror stem (35).

Item 37 is the back half of a clamp that is used to couple the universal vehicle management apparatus with integrated rating device to the vehicle mirror stem (35).

Item 38 is a nut that is used to tighten the mounting plate (31) and the hemispherical hinge (33) so that it cannot move once the desired angle has been set.

Item 39 is a mirror from a vehicle that attaches to the vehicle mirror stem (35).

Item 40 is an input means for chronological events such as time and calendar events.

Item 41 is an input means for sensor data events such as distance traveled by the vehicle from a mechanical or electronic transducer.

Item 42 is an input means for serial data events such as input from a GPS system.

Item 43 is an input means for wireless data events such as passing through a tollgate or other fixed location reference.

Item 44 is an input means for operator control such as starting or stopping the meter when a journey is complete.

Item 45 is an event filter installed by the Active Fare Schedule (46) when it is selected by the operator.

Item 46 is an active fare schedule that represents the complete menu of charges applicable to a specific journey or errand.

Item 47 is an active tariff list that contains a list of every tariff since the rating device was activated at the beginning of the journey or errand.

Item 48 is an object containing the total summary fields which will be displayed on the relevant areas on the fare meter display.

Item 48a is the total surcharges field which will be displayed on LED (20).

Item 48b is the total time field which will be displayed on LED (21).

Item 48c is the total distance field which will be displayed on LED (22).

Item 48d is the total fare field which will be displayed on LED (23).

Item 49 is the Fare Schedule Reference which will be used to access the data associated with this Fare Schedule in the Static Data Dictionary.

Item 50 is an object that represents the structure of the data stored in the active tariff list (47).

Item 50a is an event type that this tariff is associated with.

Item 50b is an event subtype that provides the context of this event, such as start or stop. This subtype may be used by code in the Tariff object (53) to provide variations on how the Process Function (53c) responds to a particular event.

Item 50c is a field that stores the time when this tariff was inserted into the current active fare schedule (46).

Item 50d is a field that stores the time when this tariff was deemed complete and no longer actively contributing to the Summary Display Fields (48).

Item 50e is a field representing the surcharge data that this tariff contributed to the Total Surcharges field (48a).

Item 50f is a field representing the time data that this tariff contributed to the Total Time field (48b).

Item 50g is a field representing the distance data that this tariff contributed to the Total Distance field (48c).

Item 50h is a field representing the fare data that this tariff contributed to the Total Fare field (48d).

Item 51 is a representation of the Fare Schedule object that is used by the Static Data Dictionary (58) to store information about all available Fare Schedules.

Item 51a is a field representing the Schedule Identifier which is used to retrieve data about a specific Fare Schedule.

Item 51b is a field representing an Event Map Reference that locates an Event Map (52) in the Static Data Dictionary (58).

Item 51c is a field representing an Event Filter Function which is installed into the Active Event Filter (45) when an Active Fare Schedule (46) is created from this Fare Schedule (51).

Item 52 is a representation of an Event Map object which is used to locate the specific tariff associated with an incoming event.

Item 52a is a field representing the Event Map Identifier which used to retrieve information about this specific Event Map.

Item 52b is a list of mappings between events and Tariffs (53).

Item 53 is a representation of a Tariff object which contains all the information necessary on how to charge a particular event.

Item 53a is a field representing the Tariff Identifier which is used to retrieve information about this specific Tariff.

Item 53b is a field representing the Tariff Type. This can take on an enumerated value for a Delta Tariff, which is a single shot charge, a Periodic Tariff, which is a charge recurring over a constant period, or a Custom Tariff, which is a completely programmable option used to implement non standard or non linear rates that cannot be specified in a structured fashion.

Item 53c is a field representing a Process Function which is a method that is called whenever an event associated with this particular tariff arrives. The Process Function has the responsibility to examine the event and the event subtype and prepare any action that needs to be taken for this event.

Item 53d is a field representing an Insert Function which is a method that is called after the Process Function (53c) has prepared the environment based on an event and event subtype. The Insert Function is responsible for inserting zero or more Active Tariffs (50) into the Active Tariff List (47) of the Active Fare Schedule (46).

Item 53e is a field representing an Update Function which is a method that is called whenever an event arrives that matches the event (50a) and event subtype (50b) one or more Active Tariffs (50) in the Active Tariff List (47). The Update Function examines the environment and the Active Tariff List (47) to determine if any of the Surcharge (50e), Time (50f), Distance (50g) or Fare (50h) fields of the Active Tariff (50) need to be updated with new values.

Item 53f is a field representing a Current Shift Function which is a method that is called to return the Tariffs decision on the current operating shift. This method can examine such features as Time of Day, Calendar Day, geographical location and any other information available in the environment to determine whether an alternate rate set should be used for a particular event.

Item 53g is a Shift Data List that contains the necessary information for charging an event during every shift that is relevant to this Tariff (53). There must always be at least 1 entry in this list, and this is the default shift that will be used when no alternate shift is appropriate. The Shift Data must correspond to the Tariff Type (53b) and is a list of entries of Delta Tariff Data (54), Periodic Tariff Data (55) or Custom Tariff Data (56).

Item 54 is a representation of a Delta Tariff Data object which contains the specific information for charging when the Tariff Type (53b) has the enumerated value of Delta Tariff.

Item 54a is a field representing a surcharge amount that will be added to the Total Surcharge (48a) when the Process Function (53c) determines that it is required.

Item 54b is a field representing a time amount that will be added to the Total Time (48b) when the Process Function (53c) determines that it is required.

Item 54c is a field representing a distance amount that will be added to the Total Distance (48c) when the Process Function (53c) determines that it is required.

Item 54d is a field representing a fare amount that will be added to the Total Fare (48d) when the Process Function (53c) determines that it is required.

Item 55 is a representation of a Periodic Tariff Data object which contains the specific information for charging when the Tariff Type (53b) has the enumerated value of Periodic Tariff.

Item 55a is a field representing an initial surcharge amount that will be added to the Total Surcharge (48a) when the Process Function (53c) determines that it is required.

Item 55b is a field representing an initial time amount that will be added to the Total Time (48b) when the Process Function (53c) determines that it is required.

Item 55c is a field representing an initial distance amount that will be added to the Total Distance (48c) when the Process Function (53c) determines that it is required.

Item 55d is a field representing an initial fare amount that will be added to the Total Fare (48d) when the Process Function (53c) determines that it is required.

Item 55e is a field representing a periodic surcharge amount that will be added to the Total Surcharge (48a) when the Process Function (53c) or Update Function (53e) determines that it is required.

Item 55f is a field representing a periodic time amount that will be added to the Total Time (48b) when the Process Function (53c) or Update Function (53e) determines that it is required.

Item 55g is a field representing a periodic distance amount that will be added to the Total Distance (48c) when the Process Function (53c) or Update Function (53e) determines that it is required.

Item 55h is a field representing a periodic fare amount that will be added to the Total Fare (48d) when the Process Function (53c) or Update Function (53e) determines that it is required.

Item 55i is a field representing the initial time offset that should be used to delay calculating charging intervals from the Periodic Tariff Data (55). Until this time has elapsed no further updates will be made. The periodic intervals will start after this amount of time has expired.

Item 55j is a field representing the period for charging intervals. Once the Initial Offset (55i) has elapsed, charging will occur at this frequency.

Item 55k is a field representing the maximum time that a Periodic Tariff is allowed to run. After this amount of time has elapsed, no further charges will be made based on this Tariff.

Item 56 is a representation of a Custom Tariff Data object. This structure of this object is completely opaque and defined by the programming of the Tariff (53) methods.

Item 57 is a representation of a Data Cache that is used to cache information from the Static Data Dictionary (58). This is an LRU cache that is used to store the Event Map (52) and Tariff (53) for rapid access when an event occurs.

Item 58 is a representation of a Static Data Dictionary that is used to hold data which changes rarely or not at all. In this embodiment that Static Data Dictionary is stored in serial flash memory (27) connected to the microprocessor (24).

Item 59 is a safety strap that is used to secure the apparatus during a collision in case the primary mount fails.

Item 70 is a video camera that continuously films the environment around the vehicle.

Item 71 is a microphone that continuously records audio from the environment around the vehicle.

Item 72 is a radar assembly that can be used to provide an estimate of vehicle speed relative to traffic.

Item 72a is an antenna or plurality of antennas used to transmit a microwave signal down the waveguide.

Item 72b is a waveguide used to create a strong directional field for the microwave antennas (72a) and (72c).

Item 72c is an antenna or plurality of antennas used to receive a signal the has reflected off a nearby object.

Item 72d is an oscillator used to generate a microwave signal that will propagate out away from the vehicle.

Item 72e is a mixer that will receive a microwave signal reflected back from an object outside the vehicle, and mix it with the transmitted signal (72d) in order to generate a low frequency signal that can be easily processed.

Item 73 is an audio and video coder decoder (CODEC) that can receive and compress the data stream from the video camera (70) and microphone (71).

Item 74 is a dual operational amplifier that takes the output of the mixer (72e) and forwards it to the A/D converter (83) with a suitable gain.

Item 75 is a gyroscope oriented to record the pitch of the vehicle.

Item 76 is a gyroscope oriented to record the roll of the vehicle.

Item 77 is a gyroscope oriented to record the yaw of the vehicle.

Item 78 is quad operational amplifier that takes the output of the 3 gyroscopes (75), (76) and (77) and forwards them to the A/D converter (83) with a suitable gain.

Item 79 is an accelerometer oriented along the Z axis of the vehicle.

Item 80 is an accelerometer oriented along the Y axis of the vehicle.

Item 81 is an accelerometer oriented along the X axis of the vehicle.

Item 82 is a quad operational amplifier that takes the output of the 3 accelerometers (79), (80) and (81) and forwards them to the A/D converter (83) with a suitable gain.

Item 83 is an A/D converter that receives analog signals from the opamps (74), (78) and (82) and digitizes them so they can be operated on in the microprocessor (87).

Item 84 is a clock calendar circuit that can provide accurate microsecond timing and time of day to the microprocessor (87).

Item 85 is a permanent storage device such as a flash memory which is used to hold the logs of the event data recorder and a calibration profile for the means of conveyance.

Item 86 is a redundant storage device such as a flash memory which is used to hold a copy of the logs of the event data recorder.

Item 87 is a microprocessor which is used to perform necessary calculations, direct memory access transfer between different conceptual blocks of the event data records, and read and store data to the permanent storage devices (85) and (86) and also the serial and wireless I/O interfaces (88) and (89).

Item 88 is a serial I/O interface that is used to communicate with devices and upload and download data to devices that are external to the event data recorder.

Item 89 is a wireless I/O interface that is used to communicate with devices and upload and download data to devices that are external to the event data recorder.

Item 90 is a sensor on the operator's seat of the vehicle to record the presence or absence of an operator.

Item 91 is a sensor on the passenger's seat or passengers' seats of the vehicle to record the presence or absence of passengers.

Item 92 is a turn signal sensor to record the activity from the vehicle turn signal indicators.

Item 93 is a steering sensor that records the current position of the steering control device for the vehicle.

Item 94 is headlight sensor to record the status of the vehicle's headlights.

Item 95 is a clutch sensor to record the status of the vehicle's clutch.

Item 96 is a transmission sensor to record the current gear of the car.

Item 97 is a sensor for the vehicle's braking system that records the status of the braking control device.

Item 98 is an engine RPM sensor.

Item 99 is a vehicle's speed sensor.

### DETAILED DESCRIPTION OF THE FIGURES

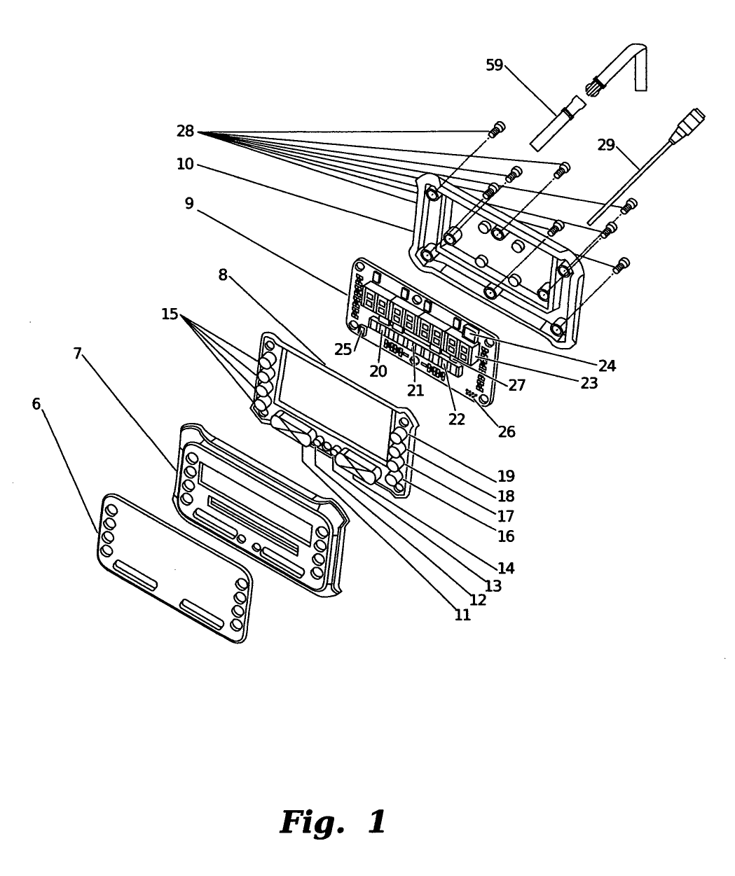

One embodiment of the present invention is shown in FIG. 1 through FIG. 6.

FIG. 1.

As is readily apparent in FIG. 1, the main body of the universal vehicle management apparatus consists of 2 clamshell enclosure halves (7) and (10), a front panel (6), a printed circuit board that contains the electronic circuits (9), and a silicon rubber sheet that provides not only the control buttons for the operator but also the environmental sealing necessary to allow operations in environmentally hazardous conditions (8). The clamshell halves are joined with screws (28), and protruding out the back is a data and power cable (29). A redundant safety strap (59) is used to secure the main body of the universal vehicle management apparatus in the event of failure of the mounting bracket.

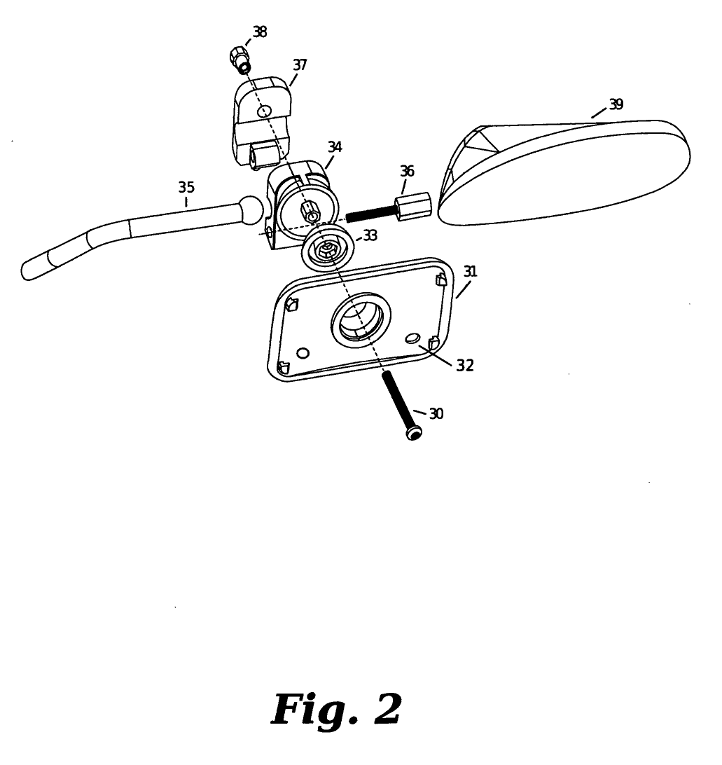

FIG. 2.

FIG. 2 shows the view of the mounting bracket used to hold the main body of the universal vehicle management apparatus. A hemispherical hinge (33) allows the mounting plate to swivel along 2 axis. A screw (30) runs through the center of the hinge, through the 2 halves of the mirror stem clamp (34) and (37), and finally into a nut (38) which is used to provide tension on the assembly once the proper alignment has been set. The two halves of the mirror stem clamp (34) and (37) slide down over the top of the mirror stem, and are held in place not only by screw (30), but also by a quick disconnect bolt (36) on the opposite side of the mirror stem. The entire assembly can be quickly removed by simply unscrewing this bolt which is easily accomplished by hand without any tools. After the bolt is removed, the entire assembly pulls straight up off of the mirror stem (35) with the two halves of the clam (34) and (37) flexing out to allow passage of the mirror stem. Similarly, replacing the assembly can be done by pushing the assembly back down over the mirror stem and tightening the quick disconnect bolt (36).

For normal operation, the main body of the assembly attaches to the mounting plate (31), while the cable (29) that is responsible for power, serial data and sensor data slides through a circular opening in the mounting plate (32). This embodiment offers theft prevention by making the universal vehicle management apparatus quickly detachable by simply unplugging the connector (29) removing the quick disconnect bolt (36) and sliding the entire assembly off the mirror stem (35). Alternate embodiments may provide theft prevention by a locking system requiring a key or custom tool to access the mounting bolts, or by physically securing the universal vehicle management apparatus permanently to the vehicle, such as would be accomplished with a weld or welded shroud.

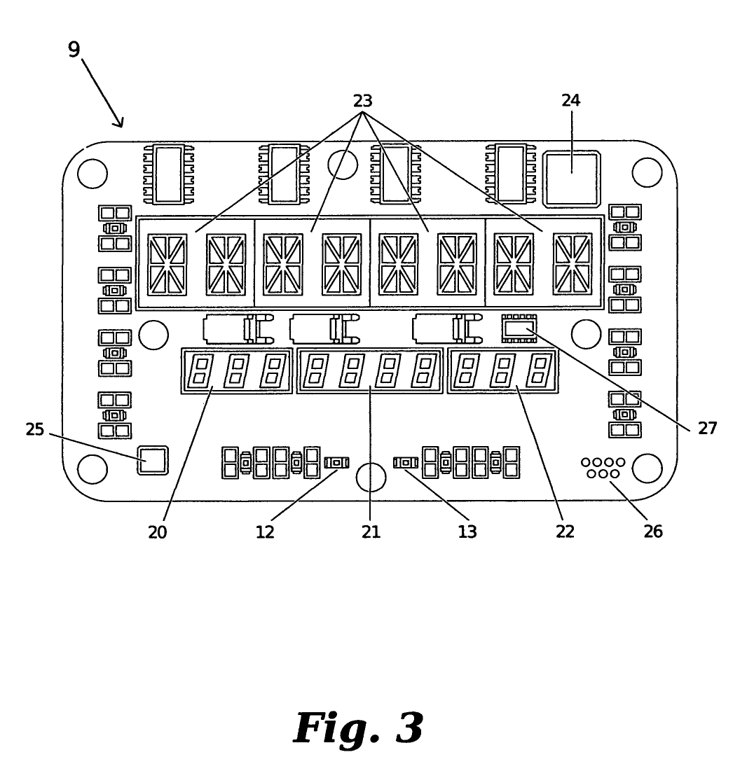

FIG. 3.

FIG. 3 shows one embodiment of the printed circuit board and electronics assembly. The microprocessor (24) is completely programmable without removing the PCB from the enclosure. A very small and simple bootloader is the only permanent piece of code in the system, and is stored in read protected flash inside the microprocessor. All other aspects of the firmware and rating system may be programmed or reprogrammed using either the serial interface (26) or the wireless interface (25).

An 8 character 14 segment alpha numeric message and fare display is included along the top of the apparatus (23). During a typical journey, this will show the characters “FARE” followed by a numerical value of maximum 4 digits representing the current total fare calculated by the programmable rating system described below. However, temporarily during the trip the alphanumeric display (23) may be used to display pertinent text messages to the user such as a surcharge being added or information regarding entering or exiting a geographical region. The LED's will return to the “FARE” display after a time sufficient for the user to read and understand the message. Alternate embodiments may use 16 segment LED displays in this location, add more characters or a second row, or use dot matrix LED displays, LCD displays, or organic LED displays for this purpose.

Another alternate function of the 14 segment alphanumeric message display (23) is to display advertising or public service messages. These messages may appear at any time. Events as discussed below can be used to trigger specific advertising messages at particular times, thus displaying an ad for a particular restaurant for example as a fare paying passenger comes within visual range of the establishment. GPS coordinates may also be used to select advertising appropriate for the display. The time of day and day of week may also be used to tailor an advertising schedule. For example, a nightclub may advertise only after 9 pm and only when picking up guests from other known entertainment establishments.

In the event the universal vehicle management apparatus is installed on a means of conveyance such as a motorcycle that is easily visible even while not riding in or on the means of conveyance, the advertising function can be used as an electronic billboard easily visible to passing pedestrians or traffic. This increases the revenue potential of an operator of a means of conveyance so he can earn money even while simply waiting for a fare paying passenger.

In a typical simple taxi function, the 3 character, 7 segment LED display (20) is used to indicate the total surcharges applied during a journey. In the event that the surcharges exceed 3 digits, the display will periodically scroll the digits. The 4 character clock LED (21) is used to indicate either the total standing time of the taxi or the total time of the journey depending on the regulations in the municipality where it is operating. The 3 character, 7 segment LED display (22) is used to indicate the total distance travelled during a journey. It is instructive to realize that what is displayed on these LEDs is actually under programming control, and as will be discussed below, very complicated fare structures may find alternate uses for them.

In order to meet certification guidelines of a municipal authority, all data programmed into the universal vehicle management system with integrated rating device must be digitally signed. The boot loader will check for an appropriate digital signature on any downloaded of code or data, and will refuse the reprogramming if the signature is invalid. Code and data is stored both in the flash memory contained inside the microprocessor (24) and in the much larger external flash device (27). Alternate embodiments may allow for multiple flash devices or removable flash devices. In the case where the apparatus is installed on a means of conveyance used in a rental fleet, and the apparatus is designed to be portable by the operator among many different vehicles, the embodiment will require an external flash device to be installed external to the enclosure for storage of vehicle specific data.

The wireless interface (25) or the serial interface (26) may also be used to download data from the universal vehicle management apparatus into vehicle management system software in the case of the operator, or for taxation or statistical purposes in the case of the government. Such data is password protected, with the encrypted password being stored in the read protected flash memory of the microprocessor (24).

This embodiment provides two indicator LEDs for unusual conditions. Because the universal vehicle management apparatus can be removed from the vehicle power supply, it is necessary to provide an internal backup battery to maintain the real time clock in the microprocessor (24). When the microprocessor detects this battery below a predetermined threshold, it will illuminate the LED (12) to indicate that the battery should be replaced. A second LED (13) is provided to indicate a general service condition. This LED will be illuminated and stay illuminated whenever an error or non standard and non recoverable condition has been detected inside the apparatus by the microprocessor (24). The LED (13) can only be turned off by a service facility after an inspection has been performed on the universal vehicle management apparatus.

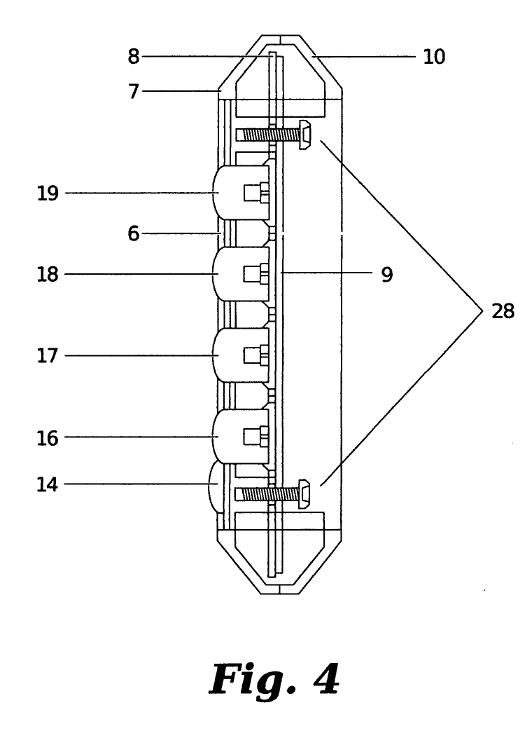

FIG. 4.

FIG. 4 shows a cut away side view of the universal vehicle management apparatus from the right. The environment seal of the main body of the universal vehicle management apparatus is provided by clamping the silicon rubber sheet (8) between the upper clamshell enclosure (7) and the lower clamshell enclosure (10). Screws (28) are used to compress this silicon rubber seal into a near hermetic state, where dust, water, and insects are prevented from passing through but air can still pass to equalize the pressure on the inside and outside of the meter. Using a near hermetic seal instead of a fully hermetic seal has the advantage of not subjecting the enclosure to the increased strain of pressurization, however it has the disadvantage of allowing condensation to collect on the inside of the enclosure in certain localities. If condensation is expected to be a serious problem in the operating region, a solvent removable conformal coating may be applied to the entire printed circuit board and electronics assembly to protect it from damage.

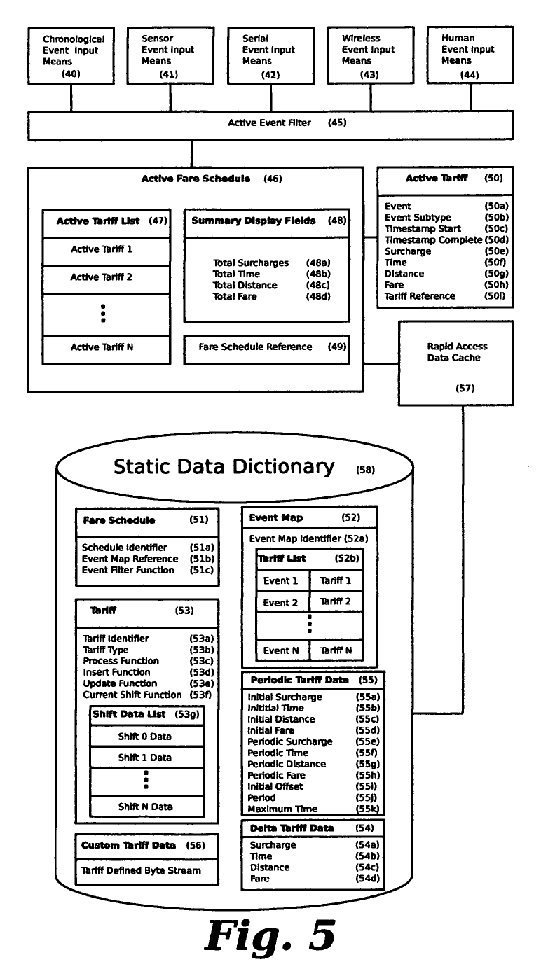

FIG. 5.

The programmable rating system employed in this embodiment is shown in block diagram form in FIG. 5. At the start of a journey or errand, a specific Fare Schedule is chosen from a list of possible schedules programmed into the rating system. As a practical matter, these Fare Schedules are generally regulated by a government authority and their use is strictly enforced. An example of distinct Fare Schedules might be the charges allowed for a trip within a local zone vs. the charges allowed for a trip outside of the zone. Distinct Fare Schedules might be required when chartering a journey in different localities that have different taxation rates.

Once a Fare Schedule has been selected by the operator, the software loads an event filter function (51c) into the Active Event Filter (45). Events are acquired and reported by mechanical and electronic means (40),(41),(42),(43),(44), which may be either internal or external to the vehicle management apparatus, or a combination of internal and external, and are passed to a software filter function. This function rejects events which are inappropriate for the currently installed Fare Schedule.

Events are first checked against all Active Tariffs (50) that have not yet been completed. Completion can be recognized by checking the Timestamp Complete field of the structure (50d). If the event type and subtype match on an Active Tariff not yet complete, the Tariff Reference (50i) field will be examined to find the Tariff structure (53). The Update Function (53e) will then be called. Finally, the Fare Schedule Reference (49) will be used to locate the Fare Schedule object (50). The Event Map Reference (51b) will be used to locate the Event Map object (52). If the specified event appears in the Tariff List (52a), the Tariff object (53) will be examined and the Process Function (53c) will be called to determine if the event is relevant and take any appropriate action. Finally, the Insert Function (53d) will be called to load any necessary new Active Tariffs into the Active Tariff List (47).

Part of the Process Function (53c) and Update Function (53e) will be to calculate any charges associated with the event, and update the local Surcharge (50e), Time (50f), Distance (50g) and Fare (50h) fields in the appropriate Active Tariff object (50). At the completion of this function, these fields will contain the relative contributions of this event to those items. The Process Function (53c) and Update Function (53e) will similarly update the Total Surcharges (48a), Total Time (48b), Total Distance (48c) and Total Fare (48d) fields of the Summary Display Fields object (48). These fields will be reported on the display of the vehicle management apparatus.

When the operator decides the journey or errand is complete and stops the meter, the Process Function (53c) associated with that event will mark all non completed Active Tariff objects (50) as complete. In the case there is any confusion by the customer over the charges of the journey, the operator will be able to scroll through the available Active Tariff objects one by one to view the partial contribution of each Active Tariff and verify correct operation. In this mode of operation, the Active Tariff fields (50e), (50f), (50g) and (50h) will be reported on the corresponding locations on the vehicle management apparatus display.

The details of the entire journey including all Active Tariff objects will be saved to an electronic logging device (27), which is included on the vehicle management apparatus. In alternate embodiments, the Active Tariff List (47) information may also be printed out on a connected printer, or saved to an external electronic diary that the customer or operator supplies which is either temporarily or permanently connected to the vehicle management apparatus.

Programming the rating system is accomplished by simply overwriting the Static Data Dictionary (58) with new data via the serial port (26) or wireless interface (25) and power cycling the vehicle management system.

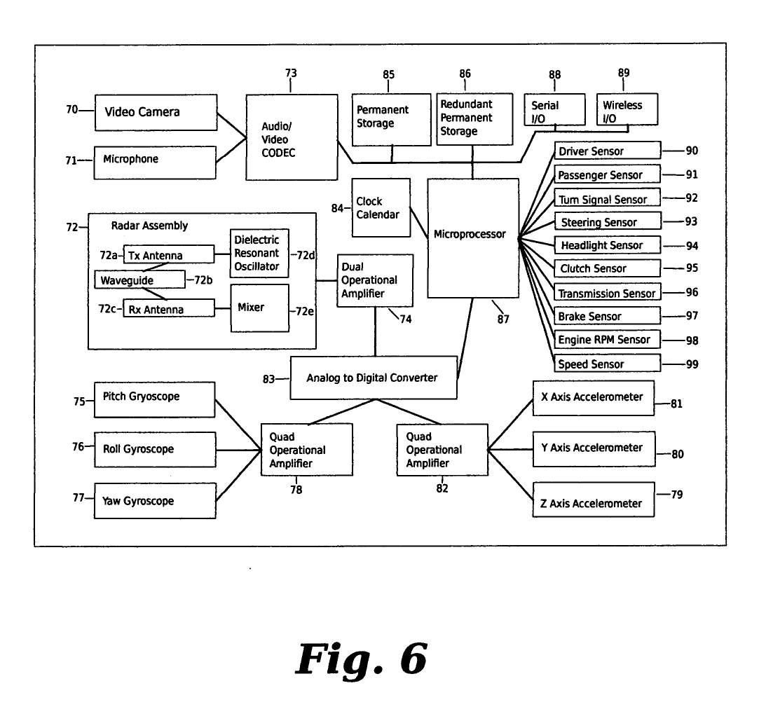

FIG. 6.

The event data recorder employed in this embodiment of the invention is shown in FIG. 6. Many of the features associated with a traditional automobile data recorder are also available on this event data recorder. This includes accelerometer input (79), (80), (81), gyroscope input (75), (76), (77), video and audio input (70) and (71), vehicle speed (99), engine speed (98), break sensor (97), clutch sensor (95), transmission sensor (96), (97) and steering status (93). A few sensors are present mostly for installation on motorcycles and autorickshaws; however they can also find value on traditional automobiles. These include the headlight sensor (94), and the passengers' (91) and driver's (90) sensor. While headlight status may not contribute substantially to vehicle safety in a traditional automobile, the effects are much more important on a motorcycle where turning the headlight on can make a difference between a car recognizing you and an accident. Similarly, the passenger seat sensors (90) and (91) do not provide helpful information in a traditional taxi, however on a motorcycle or autorickshaw where an accident has a high probability of ejecting someone from the vehicle it is best to record the exact time such an event occurs.

The event data recorder must be sealed to the environment, and it must be secured against tampering. Both of these requirements are also requirements of a universal taxi meter and universal vehicle management apparatus with integrated rating system that can be used on motorcycles and other open air means of conveyance. This allows for a novel combination of a taxi meter with an event data recorder in a single piece of hardware. Many of the components can also be shared, such as the speed sensor (99) and the clock calendar timing device (84). The event data recorder operates by taking a snapshot of all sensor values several thousand times a second and storing that information to permanent storage (85). While writing to permanent storage (85), you simultaneously update the redundant permanent storage (86).

Data is written to the permanent storage devices (85) and (86) in a circular fashion, with the oldest data being erased in order to allocate storage for new data.

There are various ways to detect an abnormal event such as a crash. The easiest is to simply watch for a large upswing or downswing on the output of the accelerometers. A rapid change in the roll gyroscope could also indicate that a motorcycle is in the process of tipping over or an automobile or Tuk-Tuk is in the process of a rolling crash. And any significant change in yaw could indicate that a spin condition or crash is in progress. Combinations of these indicators can be used to get a more accurate picture of an abnormal event such as a crash. In the event an abnormal condition is encountered that is indicative of a crash, the updates to the redundant storage device (86) is suspended so that it always contains the latest information available leading up to the accident, even if the power should fail to the event data recorder or the primary storage device should become corrupted. Updates continue to the primary storage device (85) to attempt to get all the data during and after the event.

After an event, the primary storage device (85) will continue filling with data until it would be necessary to delete data that happened after the event. At this point, the microprocessor (87) will stop recording data and wait for a reset sequence over the Serial I/O (88) or Wireless I/O (89) interfaces to clear the abnormal condition. The reset sequence will read all of the data from the permanent storage (85) and the redundant permanent storage (86), erase both blocks, and reboot the microprocessor (87).

Another feature of permanent storage (85) is to hold the calibration profile and identification of the means of conveyance. Thus, taken together with the microprocessor (87), the serial I/0 interface (88), and the serial cable (29), it constitutes an identification means for a unique ID for the means of conveyance.

An auxiliary function of the video (70) and audio (71) input is to act as a ubiquitous surveillance system by governments or private security firms. Much like cameras installed on bank ATMs or other closed circuit security cameras, the data recorded can be checked when crimes or other serious conditions have been reported in the area. This feature is most useful if the recorder aspect is kept operational even when the vehicle itself is not powered or in motion. This can provide a powerful and extremely economical means for any government to extend its municipal surveillance apparatus without significant cost.

Thus, this embodiment provides a flexible, extensible and conveniently programmable device that meets the demanding needs of taxi operators that require a range of rating options from simple journeys to demanding errand services. Alternative embodiments of the device may include additional features for entertainment and advertising such as full color LCD display, TV tuner, AM/FM stereo interface, and remote control so the operator can respond to vehicle management events without sitting on the motorcycle, which may be located in hot sun or inclimate weather while he remains under a protected structure.

Conclusion

Accordingly, the reader will see that the universal vehicle management system in its various embodiments provides a portable fare meter and data logging system that can be easily moved between vehicles, saving money for those operators who have multiple vehicles yet do not operate them all at the same time. It also provides for universal service by including protection against environmental hazards such as weather, dust and insects, allowing it to be used on open air means of conveyance such as motorcycles. Additionally, it provides:
An extremely advanced rating system for complex fare calculations
Multiple currency support and ration coupon support for operation in times of national crisis
Integrated advertising display
Integrated event data recorder
Advanced virtual queueing system

While the above description contains many specifics, these should not be construed as limitations on the scope, but rather as an example of one embodiment of the invention. Many variations are possible, including but not limited to the following:

(a) the Tariff object including a text memo to display to the passenger when a charge is incurred

(b) removing the summary display fields (48) and manually adding the Active Tariff fields (50e),(50f),(50g),(50h) for display

(c) eliminating the hierarchical nature of the programming objects, associating all necessary data currently contained in the Tariff objects and Event Map directly to a Fare Schedule object (51) and using procedural code to calculate the display elements

(d) removing the active event filter and letting the normal process discard the events

(e) replacing periodic events with multiple delta events at the defined period

(f) more display fields (48) could be added, such as a text memo field, distinct waiting time and moving time fields, distinct journey fare and errand fare charges

(g) several event input means could be combined, or new event input means could be added

Thus the scope of the invention should be determined not by the embodiments illustrated, but by the appended claims and their legal equivalents.

We claim:

1. A fare calculation apparatus for installation on any means of conveyance, including open air means of conveyance, used in for hire transport services, said means of conveyance controlled by an operator, said apparatus consisting of:
a. an enclosure means consisting of a first side and a second side that mates with said first side, and
b. a sealing means in contact with said first side and said second side to seal said enclosure means against environmental hazards, and
c. a plurality of sensing means for sensing rating parameters, and
d. a first processing means located inside said enclosure means, said first processing means programmed with a rating algorithm, said rating algorithm including the ability to calculate fares based on said plurality of rating parameters, and
e. a tamper prevention means to prevent unauthorized access to said first processing means, and
f. a display means
whereby said operator can use said apparatus to price services in real time according to a defined algorithm.

2. The apparatus in item 1, where said plurality of rating parameters is taken from the group consisting of transit distance, transit duration, time of day, day of week, day of year, interval of operation below a specified speed, operating surcharges, geographic location, weather during transit, type of terrain, type of conveyance and operator defined events.

3. The apparatus in item 2, where said defined algorithm includes one or more surcharge tariffs that are mapped to events associated with said rating parameters where said events initiate programmable actions that calculate the price.

4. The apparatus in item 3, where said defined algorithm is digitally signed.

5. The apparatus in item 1, additionally including a mounting means consisting of
a. a first attachment means to said enclosure means and
b. a second attachment means to said means of conveyance and
c. a quick disconnect means to detach said enclosure means from said means of conveyance.

6. The apparatus in item 5, where said second attachment means is located on the mirror assembly of said means of conveyance.

7. The apparatus in item 5, where said first attachment means consists of a mounting plate in contact with said enclosure means and a pivot assembly to adjust the angle of said enclosure means relative to said means of conveyance.

8. The apparatus in item 5, where said quick disconnect means consists of
a. a clamping means in contact with first attachment means and second attachment means and
b. a quick disconnect screw that can be adjusted by hand
whereby said enclosure means can be removed from said means of conveyance.

9. The apparatus in item 5, additionally including a memory means coupled to said processing means to store calibration profiles of a plurality of means of conveyance.

10. The apparatus in item 9, additionally including an identification means for determining a unique identifier of said attached means of conveyance.

11. The apparatus in item 10, where said processing means loads a calibration profile for said attached means of conveyance by matching said unique identifier with stored calibration profiles in said memory means.

12. The apparatus in item 11, where said identification means is a serial communication line to a storage means including a unique ID code permanently attached to said means of conveyance.

13. The apparatus in item 12, where said serial communication line runs an encrypted protocol to read said unique ID code from said storage means.

14. The apparatus in item 5, additionally including a communication means coupled to said processing means, where said communication means is used to communicate with a storage means on said attached means of conveyance, said storage means containing a calibration profile of the means of conveyance.

15. The apparatus in item 14, where said communication means is a serial communication line.

16. The apparatus in item 15, where said storage means is a processing means in communication with a memory.

17. The apparatus in item 16, where said serial line runs an encrypted protocol to read said calibration profile from said storage means.

18. The apparatus in item 1, where said plurality of sensing means includes one or more sensing means that receive data from an event data recorder installed on an open air means of conveyance comprising
a. a second processing means, and
b. a communication means in contact with said first processing means, and
c. a plurality of second sensing means.

19. The apparatus in item 18, where said plurality of second sensing means is selected from the group consisting of acceleration sensing means, speed sensing means, sound sensing means, video sensing means, rotation sensing means, time sensing means, passenger presence sensing means, turn signal sensing means, steering sensing means, headlight sensing means, clutch sensing means, transmission sensing means, brake sensing means, engine speed sensing means and proximity sensing means.

20. The apparatus in item 19, where said event data recorder additionally stores a calibration profile of said means of conveyance.

21. The apparatus in item 20, where said event data recorder additionally includes an encrypting means for encrypting data on said communication means.

22. The apparatus in item 1, additionally including a queueing means comprising
a. a wireless communication means in communication with said first processing means, where said wireless communication means transmits its presence and listens for transmissions from additional apparatus in a predetermined region, and
b. an ordering algorithm running on said first processing means to update in real time the priority number of said apparatus within a population of said additional apparatus, and
c. a notification means for notifying said operator in real time of said priority number.

23. The apparatus in item 22 where said notification means is an alphanumeric display on said display means and said ordering algorithm is a simple sort algorithm based on arrival time of said apparatus and each said additional apparatus in said predetermined region.

24. A system for calculating the fare in for hire services, said for hire services selected from the group consisting of passenger transport, non passenger transport, and errands, said system comprising:
a. a distance tracking means for generating events based on distance traveled
b. a rating means comprising
1. a storage means to store tariff information, said tariff information including charges in a plurality of currencies
2. a converter means to convert said distance events into charges in a plurality of currencies using said tariff information
3. a calculating means to track simultaneous total charges in a plurality of currencies where said currencies are selected from the group consisting of local currencies, ISO currencies, discount coupons and ration coupons
c. a display means for displaying simultaneous total charges in a plurality of currencies where said fare is the aggregate total of all the charges displayed in the plurality of currencies.

25. The system in item 24, additionally comprising one or more sensing means for generating rating events, said sensing means selected from trip duration, time of day, day of week, day of year, interval of operation below a specified speed, operating surcharges, geographic location, weather, terrain, type of conveyance and operator defined events.

26. The system in item 24, said rating means additionally comprising one or more converter means to convert said sensing events into charges, said charges to be added to total charges.

27. The system in item 24, where said charges in a plurality of currencies may be positive or negative.

28. A method for providing for hire transport services comprising:
a. providing a means of conveyance that is controlled by an operator and can transport one or more passengers
b. providing a portable fare calculation device that can be installed temporarily in said means of conveyance
c. providing a portable display means in communication with said portable fare calculation device
d. providing advertisements to said passengers during a journey
whereby said operator can offer for hire transport services to passengers in any means of conveyance, including means of conveyance that are not primarily used for hired passenger transport, charge according to a predetermined algorithm sensitive to both distance and time, and subsidize the cost through advertising without requiring a permanent fare metering installation in the means of conveyance.
